(19) United States
(12) Patent Application Publication
(10) Pub. No.: US 2013/0064507 A1
(43) Pub. Date: Mar. 14, 2013

(54) WAVELENGTH DIVISION MULTIPLEXING DEVICE

(71) Applicants: Sven MAHNKOPF, Horsham, PA (US); Duane LOUDERBACK, Stateline, NV (US); Mitchell HARRIS, Verdl, NV (US)

(72) Inventors: Sven MAHNKOPF, Horsham, PA (US); Duane LOUDERBACK, Stateline, NV (US); Mitchell HARRIS, Verdl, NV (US)

(21) Appl. No.: 13/229,500

(22) Filed: Sep. 9, 2011

(51) Int. Cl. G02B 6/26; B23P 11/00

(52) U.S. Cl. 385/52; 29/428

(57) ABSTRACT

A technology for wavelength division multiplexing light of a plurality of different wavelengths into one or more optical fibers is disclosed. In a first main embodiment, the light is multiplexed and turned by a designated angle using two lens arrays and a flat surface that functions as a mirror. In a second embodiment, a waveguide-based combiner structure multiplexes and turns a plurality of light beams of different wavelengths.

### GOVERNMENT INTERESTS

The United States Government has a paid-up license in this invention and the right in limited circumstances to require the patent owner to license others on reasonable terms as provided by the terms of Contract No. FA8750-05-C-0110 awarded by the United States Government.

### TECHNICAL FIELD

The present invention is directed generally to transmitting light. The unique advantage of the technology disclosed herewith is to multiplex light at different wavelengths or carrier frequencies at low losses over a very large temperature range.

### BACKGROUND ART

For the transmission of optical signals, generally two different approaches are presently being deployed. In a first approach, the transmission of multiple signals is facilitated over a single optical fiber with each signal having a different carrier frequency.

This approach is commonly referred to as dense or coarse wavelength division multiplexing (DWDM or CWDM) with CWDM technology being commonly used in long reach (LR) or extended reach (ER) transceiver products.

A second approach facilitates the transmission of optical signals over a strand of optical fibers with one signal per fiber. The latter approach is henceforth referred to as parallel technology and is commonly used in short reach (SR) transceivers based on the 40GBASE-SR4 or 100GBASE-SR10 communication standards. The parallel transceiver technology does not utilize a key advantage of optical fibers compared to copper wires: the ability of a single optical fiber to carry multiple data signals of different carrier wavelengths in a single fiber without resulting in compromises on signal integrity.

Two main transmitter optical engines are used in these parallel transceiver technologies, both of which are important prior art to this disclosure and incorporated herewith. As a representative example of the first group, U.S. Patent No. 2009/0016734 A1 to Hamazaki discloses an optical block for parallel transmission using planar waveguide technology.

As an example of the second group of parallel technologies, U.S. patent application Ser. No. 12/316,211 to Noguchi discloses an optical turning block based on lens arrays. Particularly to the latter technology, many comparable topologies exist including those in which the light is propagating straight from the sources to the fibers and turning the signal electrically instead of optically. The Prizm LightTurn connector, a trademark of US Conec Limited, for example, is a device that terminates a strand of 12 optical fibers to couple light to and from an array of photodetectors or light sources, respectively, with one fiber for each light source or photodetector. An array of curved reflective surfaces focuses the individual emission onto the facet. Similarly, U.S. Pat. No. 7,887,243 to Abel et al. discloses a miniature mechanical transfer (MT) optical coupler. However, the above disclosures do not discuss the option to multiplex a plurality of wavelengths into a single optical fiber. The main technologies utilized there are based on dispersive optical elements such as filters, diffraction gratings or, less common, prisms as discussed below. U.S. Pat. No. 7,184,621 to Zhu and U.S. Pat. No. 6,941,047 to Capewell et al., which are hereby incorporated by reference, describe a system of cascaded thin film filters that can multiplex and demultiplex four or more wavelengths to and from a single fiber. U.S. Pat. No. 4,299,488 to Tomlinson and U.S. Pat. No. 4,198,117 to Kobayashi, which are hereby incorporated by reference, describe a multiplexing and demultiplexing technique in which a reflection grating multiplexes multiple wavelengths incident from a set of fibers and demultiplexes into a second set of fibers. While these technologies can utilize the same optical engine to multiplex and demultiplex optical signals, they require a very careful alignment of the constituent optical components to function at high data rates with low insertion loss.

Another important prior art is the combinatorial problem of optimizing the packing of two-dimensional unit objects in an envelope circle of minimum diameter. In the context of this disclosure, the envelope circle corresponds to the object size when imaging a plurality of light sources onto a single optical fiber facet. Reis discussed the dense packing of equal circles 301 in an envelope circle 302 (G. E. Reis, Dense Packing of Equal Circles within a Circle, Math. Mag. 48 (1975) 1, 33-37). Cantrell discussed the optimized packing of eight equal squares 303 in an envelope circle 304 (D. W. Cantrell in communication with E. Friedman, March 2002, DWCantrell@sigmaxi.org).

Finally, numerous well-established technologies exist using arrayed waveguides to multiplex and demultiplex different wavelengths, particularly for dense wavelength division multiplexing applications. As an example, U.S. Pat. No. 5,002,350 to Dragon discloses the use of arrayed waveguides as an optical multiplexer and demultiplexer. The size of this type of multiplexer is preventing it from utilization in transceivers with a compact form factor.

### SUMMARY OF THE INVENTION

The present invention discloses two main embodiments to optically multiplex a plurality of wavelength division multiplexed signals. The embodiments utilize a system of lenses and a planar waveguide combiner structure, respectively, to simultaneously multiplex and spatially turn the signal by a designated angle.

Simplification of the electrical conduction path from the electrical connector to and from the light emitter and detector, respectively, is a desirable design criterion for optical transceivers. Parasitic inductances and capacitances can substantially compromise the signal integrity, particularly at higher data rates. At the same time, it can be important to limit the interconnect cabling complexity by allowing the ingress and regress of a plurality of optical signals over a single optical fiber. The devices disclosed herewith present compact solutions to both of these system demands.

### BRIEF DESCRIPTION OF THE DRAWINGS

FIG. 1A depicts a side view of a preferred embodiment of a multiplexing device designed to operate with four light sources. The view represents a slice through the center of the device to show internal structures.

FIG. 1B depicts the front view of a preferred embodiment of a multiplexing device designed to operate with four light sources.

FIG. 1C depicts the bottom view of a preferred embodiment of a multiplexing device designed to operate with four light sources.

FIG. 1D depicts a perspective view of a preferred embodiment of a multiplexing device designed to operate with four light sources.

FIG. 2A depicts the side view of an embodiment of a 6×4 wavelength division multiplexer that couples the emission from 24 light emitters into four fibers with each fiber carrying light of four different wavelengths. The view represents a slice through the center of the device to show internal structures.

FIG. 2B depicts the front view of an embodiment of a 6×4 wavelength division multiplexer that couples the emission from 24 light emitters into four fibers with each fiber carrying light of four different wavelengths.

FIG. 2C depicts the bottom view of an embodiment of a 6×4 wavelength division multiplexer that couples the emission from 24 light emitters into four fibers with each fiber carrying light of four different wavelengths.

FIG. 2D depicts a perspective view of an embodiment of a 6×4 wavelength division multiplexer that couples the emission from 24 light emitters into four fibers with each fiber carrying light of four different wavelengths.

FIG. 3A shows prior art depicting the highest packing density of square objects in a circle.

FIG. 3B shows prior art depicting the highest packing density of circular objects in a circle.

FIG. 4A depicts a side view of a preferred embodiment of a multiplexing device designed to operate with four light sources that includes a fiber connector receptacle. The view represents a slice through the center of the device to show internal structures.

FIG. 4B depicts the front view of a preferred embodiment of a multiplexing device designed to operate with four light sources that includes a fiber connector receptacle.

FIG. 4C depicts the bottom view of a preferred embodiment of a multiplexing device designed to operate with four light sources that includes a fiber connector receptacle.

FIG. 4D depicts a perspective view of a preferred embodiment of a multiplexing device designed to operate with four light sources that includes a fiber connector receptacle.

FIG. 5A depicts a side view of a preferred embodiment of a multiplexing device based on a bent waveguide combiner structure designed to operate with four light sources. The view represents a slice through the center of the device to show internal structures.

FIG. 5B depicts the front view of a preferred embodiment of a multiplexing device based on a bent waveguide combiner structure designed to operate with four light sources.

FIG. 5C depicts the bottom view of a preferred embodiment of a multiplexing device based on a bent waveguide combiner structure designed to operate with four light sources.

FIG. 5D depicts a perspective view of a preferred embodiment of a multiplexing device based on a bent waveguide combiner structure designed to operate with four light sources.

FIG. 6A depicts the side view of an embodiment of a 4×4 wavelength division multiplexer based on a stack of four bent waveguide combiners to couple the emission of 16 light sources into four optical fibers with each fiber carrying light of four different wavelengths. The view represents a slice through the center of the device to show internal structures.

FIG. 6B depicts the front view of an embodiment of a 4×4 wavelength division multiplexer based on a stack of four bent waveguide combiners.

FIG. 6C depicts the bottom view of an embodiment of a 4×4 wavelength division multiplexer based on a stack of four bent waveguide combiners.

FIG. 6D depicts a perspective view of an embodiment of a 4×4 wavelength division multiplexer based on a stack of four bent waveguide combiners.

### DETAILED DESCRIPTION OF THE INVENTION

In accordance with the present invention, it has been discovered that the proposed wavelength division multiplexing device operates nearly independent from the polarization distributions of the light sources and is very insensitive to the precise wavelengths of the channels, therefore making it highly tolerant to errors in center wavelength, spectral width, or wavelength shifts due to temperature variations.

It is believed that the reason for this highly polarization and wavelength insensitive behavior is the absence of a dispersive optical element such as a filter, prism, or diffraction grating to multiplex the optical signal of the proposed embodiments. While some polarization or wavelength dependence is introduced through material dispersion and small polarization-dependent Fresnel reflections at optical interfaces, these effects are minimal due to operation near surface normal incidence.

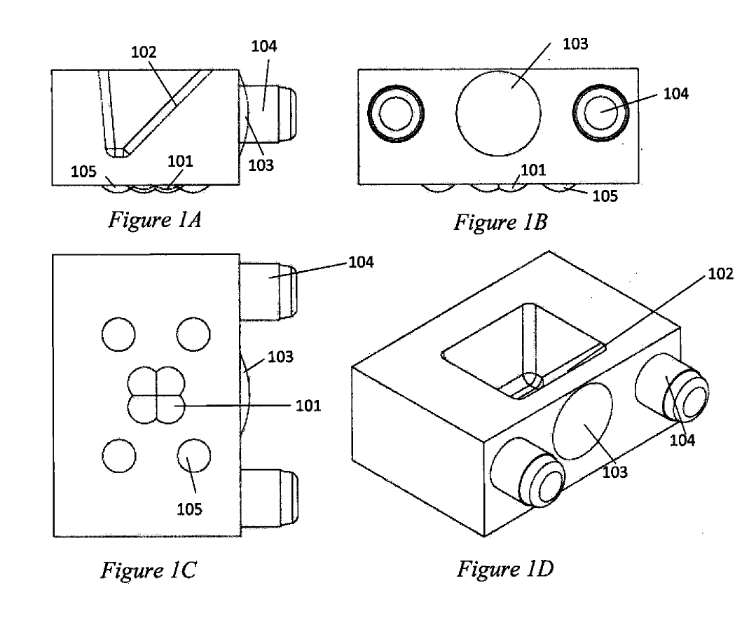

In a preferred embodiment illustrated in FIG. 1A through FIG. 1D, the emission from each light source is first collimated by individual lenses 101. The light source could for example be a vertical cavity surface emitting laser, but is not limited to that selection. Each light source has a different emission wavelength. Alignment features 105 assist in an alignment of the multiplexing device to the array of light sources such that the vertex of each collimating lens surfaces 101 is laterally coinciding an aperture center of a light source while establishing a designated distance between the light source and the collimating surface vertex such that the emission from the light source is collimated after passing through the collimating surface. The collimated beam is turned ninety degrees through total internal reflection off of a planar surface 102 angled at 45 degrees. The individual beams are finally spatially combined by a common focusing lens 103. Alternatively, surface 102 is curved to simultaneously steer and focus the individual emissions with surface 103 being planar. Since all individually collimated beams are to be combined into the same optical fiber with finite numerical aperture, a tight packing of the sources is an important design criterion. Alignment features 104 assist in an alignment of the device to a mechanical block holding an optical fiber. The alignment features 104 and 105 can either be a recess or a protrusion. Protrusions can include alignment pins. Alignment pins 104 could for example satisfy the mechanical specifications of alignment pins of a mechanical transfer (MT) connector, alignment features 105 could for example exhibit the same shape as the main lens elements 101 to avoid replacing the tool when manufacturing a mold structure for injection molding.

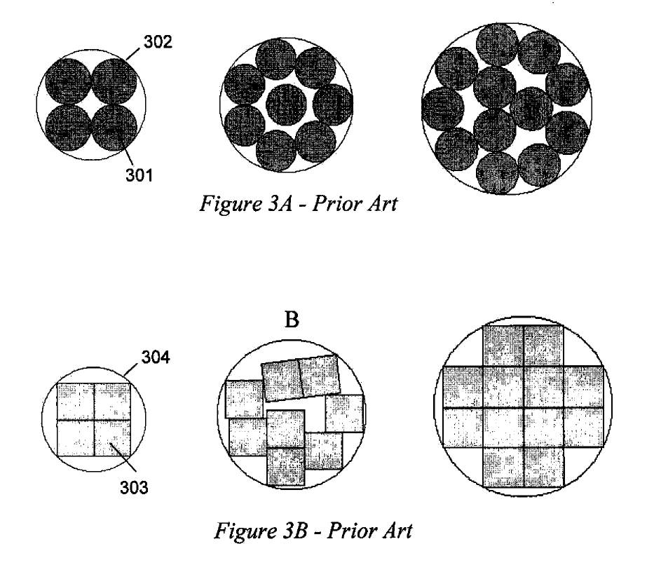

When multiplexing optical signals with tighter wavelength spacing, the same epitaxial growth can be used with an additional structure that introduces a systematic phase shift during each round trip in the laser cavity. In this case, the VCSEL apertures are circular and can be packed in close spatial proximity. The packing problem is therefore defined as packing unit circles 301 into an envelope circle 302. FIG. 3A illustrates the preferred packing configurations for 4, 8, and 12 circular light sources packed into a circle with minimum envelope radius.

When multiplexing coarse wavelength division multiplexed (CWDM) signals, preferably different epitaxies are used to generate the light emission. This forces separate die placement with die footprints being typically of square or rectangular shape. The packing problem can therefore be described as packing squares 303 into an envelope circle 304. FIG. 3B illustrates the highest packing density configurations for 4, 8, and 12 square footprint light sources packed into a circle with minimum envelope radius.

The magnification of the object can be approximated by the ratio of the numerical aperture (NA) of the light source and the numerical aperture of the optical fiber and a topology factor that describes the radius R of the envelope circle normalized by the separation of light emitting element centers. For example, when multiplexing 4 CWDM VCSELs with a beam divergence half angle of 20 degrees into a single multimode fiber with an NA of 0.2, the magnification is approximately given by

$$\begin{matrix}{f}_{col} \leq \frac{s / 2}{tan 20 °} \\ {f}_{foc} \geq \frac{\sqrt{2} \cdot \frac{s}{2} + \frac{s}{2}}{0.2} = \frac{\frac{s}{2} \cdot ( 1 + \sqrt{2} )}{0.2}\end{matrix} \} ⇒ M \geq \frac{\frac{s}{2} \cdot ( 1 + \sqrt{2} ) \cdot tan 20 °}{0.2 \cdot \frac{s}{2}} = {\underbrace{[ 1 + \sqrt{2} ]}}_{\begin{matrix}topology \\ factor\end{matrix}} \cdot {\underbrace{[ \frac{tan 20 °}{0.2} ]}}_{{\approx ratio}_{of NAs}} = 4.4$$

in which s denotes the VCSEL-to-VCSEL aperture center separation, f_{col} denotes the focal length of the four individual collimating lenses (for example, lenses 101 in FIG. 1C), and f_{foc} is the focal length of the common focusing lens (for example, lens 103 in FIG. 1C). In a preferred embodiment, the multiplexing device is fabricated out of a single optically transparent material, in which case, the magnification describes the ratio of the two radii of curvature for the focusing and collimating lenses.

For comparison, in a linear arrangement of the VCSEL sources, the magnification required to still satisfy the numerical aperture of the fiber increases to about 7.3. The larger magnification results in a larger spot at the facet of the multimode fiber, therefore resulting in reduced alignment tolerances or larger insertion losses or both.

The more colors that are multiplexed into a single fiber, the more demanding the alignment process will become for a given fiber NA. While a larger fiber NA such as those from photonic crystal fibers can of course push this boundary, using the preferred packing configuration remains an important design factor.

In an exemplary structure, the emissions from 4 light sources, each having a different wavelength, are combined into a single 50 μm core multimode fiber. Both the collimating lenses and the focusing lens are described by aspheric surface sagitta described by

$$z ( r ) = \frac{{r}^{2}}{R} \cdot \frac{1}{1 + \sqrt{1 - ( 1 + k ) \cdot {( r / R )}^{2}}} + {\sum }_{j} {α}_{j} {r}^{2 j}$$

in which R is the base radius of the lens, k is its conic constant, and αⱼ are the higher order deviations from a spherical shape. Four collimating lenses are arranged in a 2×2 configuration with base radius R of 190 μm, a vanishing conic constant k, and higher order deviations α₁ of 0.201 mm⁻¹, α₂ of −43.354 mm⁻³, and α₃ of −135.015 mm⁻⁵. The center-to-center separation s of the lenses is 250 μm. The single focusing lens is defined by a base radius R of 920 μm, a conic constant k of −0.093, and higher order deviations α₁ of −0.01 mm⁻¹, α₂ of −0.354 mm⁻³, and α₃ of −0.046 mm⁻⁵. The parameters can be can be adjusted to yield vanishing factors α₁ if desired.

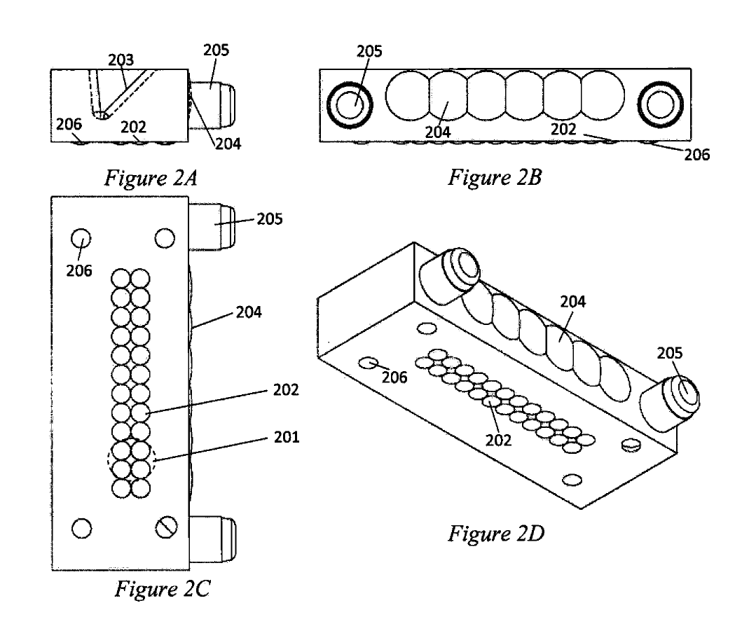

FIG. 2 illustrates an example of a 6×4λ configuration in which 24 channels are coupled into 6 fibers with 4 different wavelengths multiplexed into each of the 6 fibers can be implemented by configuring six groups of light sources in a linear array. The light sources in each of the six groups are arranged in a 2×2 configuration as described before. A group 201 of 4 collimating lenses 202 is also packed in a 2×2 topology to reflect the spatial arrangement of the light sources. The 4 beams incident from each group are multiplexed in the same fashion as described in the previous embodiment. Individual collimating lenses 202 collimate a beam incident from a light source. The collimated beams are turned 90 degrees by total internal reflection off of a planar surface 203. Groups of 4 collimated and turned beams are focused onto the facet of an optical fiber using a focusing lens 204. Again, alignment features 205 and 206 facilitate alignment of the device to the fiber array and array of light sources, respectively. A zero-dimensional array of an entity is associated with a single entity. A one-dimensional array of an entity is referred to as a spatial alignment of a plurality of entities along a straight line. A two-dimensional array of an entity is associated with an arbitrary distribution of entities on a plane.

In a third preferred embodiment, the multiplexing device includes a receptacle for a transistor outline (TO) header or a transistor outline (TO) cap, a 2×2 array of optically transmissive curved surfaces to individually collimate the emission of 4 light sources of different wavelengths, a focusing lens to multiplex the four collimated beams onto a single multimode fiber facet, and a receptacle for a standard fiberoptic connector such as Lucent connector (LC), standard connector (SC), straight tip (ST), or fiber channel (FC). As before, the embodiment can be generalized to multiplex more than one group of light beams of different wavelengths into an array of optical fibers and include a receptacle for a strand of fibers such as a mechanical transfer (MT) fiber connector.

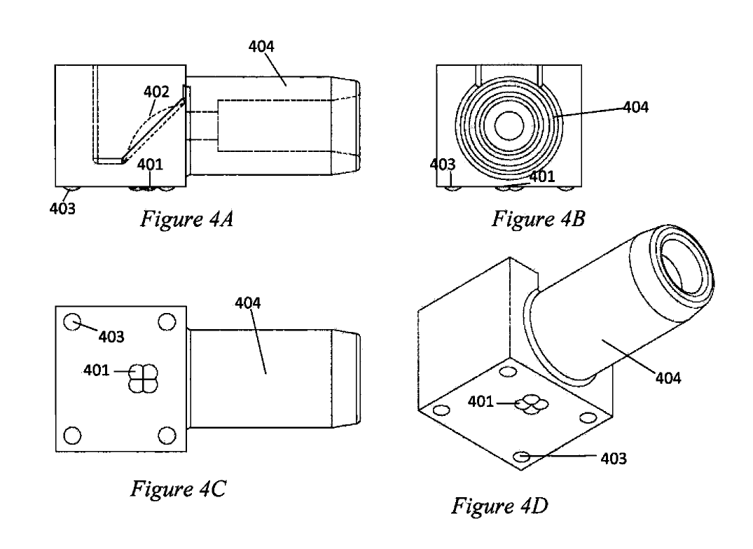

In a fourth preferred embodiment illustrated in FIGS. 4A through 4D, emissions from a plurality of light sources are again collimated by curved surfaces 401. The collimated beams are turned and simultaneously focused using a reflective curved surface 402. The embodiment includes a fiber connector receptacle 404 to establish a designated distance between the curved reflective surface and the fiber facet. As before, mechanical alignment features 403 can optionally facilitate improved alignment between the light sources and the multiplexing device.

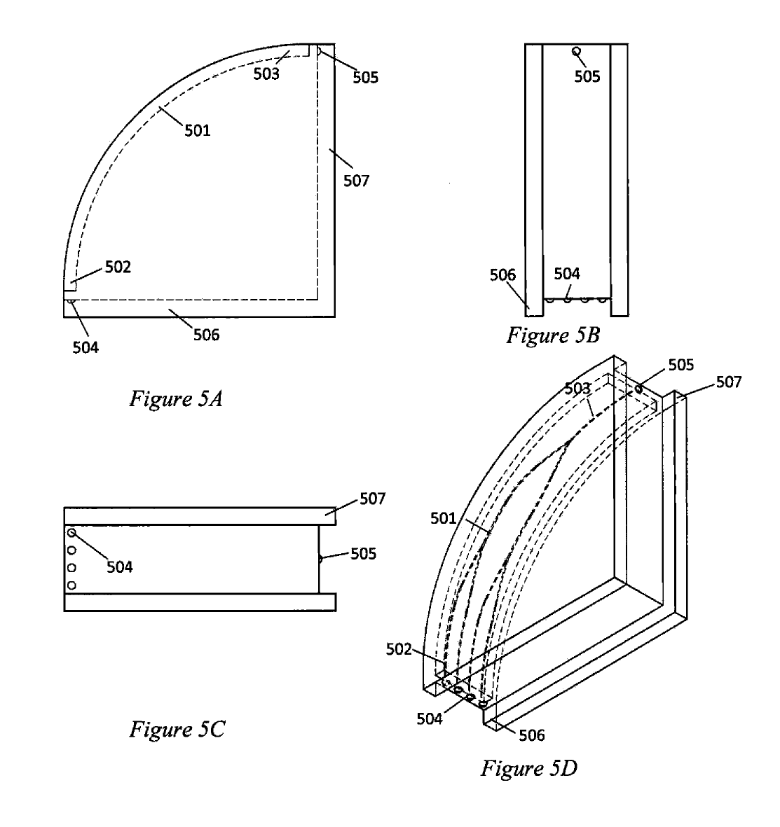

In another preferred embodiment illustrated in FIGS. 5A through 5D, a waveguide combiner structure 501 with input waveguides 502 and a common output waveguide 503 is simultaneously combining a plurality of beams of different wavelengths from the light sources and turning the signal from the surface normal direction to a direction coplanar to the subcarrier. The bent waveguide combiner is defined as part of a solid optical multiplexing device. In this embodiment, the bent waveguide is replacing the focusing lens array to spatially combine the emissions from the individual light sources which are preferably arranged collinearly. The light emitted from each light source has a different wavelength and each emission is coupled into a designated input waveguide 502. Pairs of two input waveguides 502 are bent to spatially combine into a pair of waveguides 501, which are in turn bent to combine into a common output waveguide 503 as illustrated in FIG. 5D. As can be appreciated from the arrangement illustrated in FIGS. 5A and 5D, waveguide combiner 501 with input waveguides 502 and output waveguides 503 may be positioned to provide optical paths that follow a selected curve. For example, such paths may be bent along a selected radius of curvature. Thus, in this embodiment a waveguide combiner 501 is positioned to provide optical paths having a selected curvature. The waveguide combiner 501 includes a plurality of input waveguides 502 having entrance facets aligned along a first axis and a single output waveguide 503, and the waveguide combiner simultaneously multiplexes a plurality of light beams of different wavelengths and steers the light along the selected curvature and bends the light by a designated angle. The designated angle is preferably ninety degrees. The curvature of the waveguide combiner is selected to be sufficiently small to yield acceptable optical propagation losses and the input waveguides are preferably spaced equidistant.

As in the first embodiment, the wavelength division multiplexer operates again without the use of an explicit dispersive optical element such as a filter, prism, or diffraction grating. The multiplexing device can furthermore feature an array of curved surfaces 504 to increase the coupling efficiency from the light sources into the individual input waveguides 502. Furthermore, the embodiment can include a curved surface 505 at a designated distance from the output facet of the output waveguide 503 to increase the coupling efficiency from the single output waveguide to the optical fiber. Mechanical alignment features 506 can optionally establish a designated distance between the light sources and said array of curved surfaces 504. Alignment features 506 can furthermore be used to establish a designated lateral spatial alignment between the light sources and the curved surfaces 504. Similarly, mechanical alignment features 507 can optionally establish a designated distance between curved surface 505 and an optical fiber entrance facet. Alignment features 507 can furthermore be used to facilitate a lateral spatial alignment between curved surface 505 and an optical fiber entrance facet.

The waveguide combiner can be fabricated by defining a mold that includes grooves or channels that are subsequently filled and cured with a polymer that exhibits a higher index of refraction than the body of the mold. Alternatively, the multiplexing device can be fabricated by defining a mold that features a recess into which a polymer waveguide slab can be inserted and attached. The polymer waveguide combiner is fabricated independently and is inserted and secured into the predefined cutout.

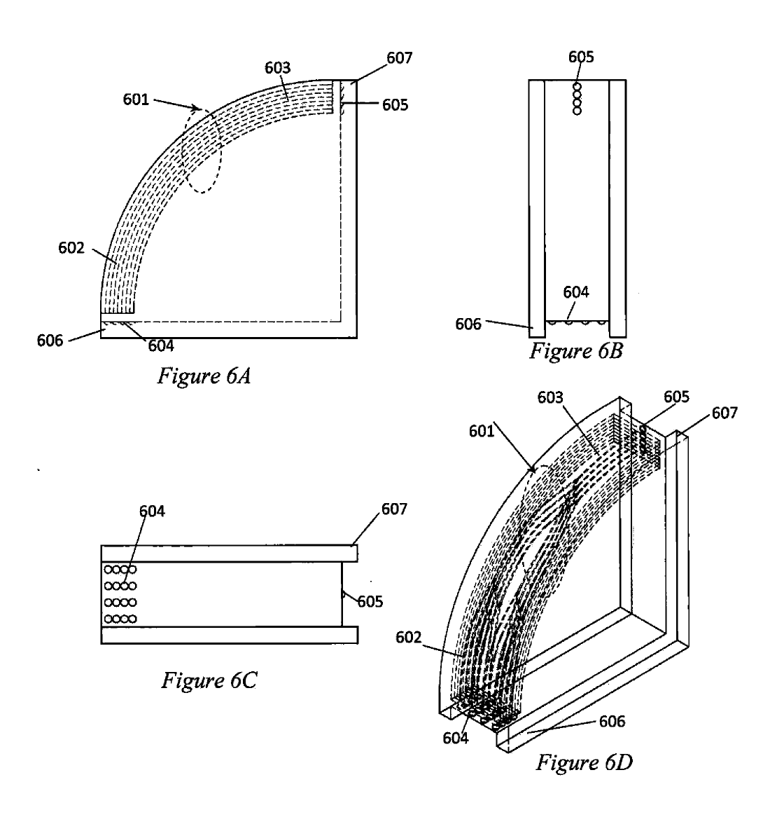

FIGS. 6A through 6D illustrate an exemplary embodiment of a 4×4λ multiplexing device utilizing the waveguide combiner topology. A plurality 601 of waveguide combiners are arranged in an array, and the array of waveguide combiners simultaneously multiplexes a plurality of light beams of different wavelengths and steers the light by a designated angle and a selected curvature. The curvature is selected to be sufficiently small to yield acceptable optical propagation losses. The waveguide combiners include cladding layers with lower refractive index that are explicitly shown in FIG. 6A and FIG. 6D. Each of the waveguide combiners are positioned to provide optical paths having the selected curvature, and each waveguide combiner includes a plurality of input waveguides 602 having entrance facets aligned along a first axis and a single output waveguide. Preferably, the waveguide combiners are stacked such that the output waveguide 603 of each waveguide combiner has an output end that is aligned along a second axis that is perpendicular to the first axes of the input waveguides of each waveguide combiner. The light sources of different wavelengths are arranged in close proximity and parallel to the first axis of input waveguides with the same spacing as the spacing between the input waveguides such that the light can be optimally coupled from the light sources into the input waveguides. A first array of curved surfaces 604 can optionally be used to improve the coupling efficiency from the light sources into the waveguide combiner input waveguides 602. A second array of curved surfaces 605 can optionally be used to improve the coupling efficiency from the output waveguides 603 to the optical fibers. Mechanical alignment features 606 can optionally establish a designated distance between the light sources and said first array of curved surfaces 604. Alignment features 606 can furthermore be used to establish a designated lateral spatial alignment between the light sources and the curved surfaces 604. Similarly, mechanical alignment features 607 can optionally establish a designated distance between said second array of curved surfaces 605 and an array of optical fibers. Alignment features 607 can furthermore be used to facilitate a lateral spatial alignment between said second array of curved surfaces 605 and an array of optical fibers.

Preferably all transmissive surfaces of the multiplexing device embodiments described above are coated with a dielectric layer structure that is antireflective in the wavelength range of the light sources.

Both the bent-waveguide-based and lens-based multiplexing mechanisms could in principle be used as a demultiplexer as well when incorporating filter structures at the photodetector end to discriminate between the different wavelength channels. However, in both cases a minimum loss of 6 dB when demultiplexing 4 wavelengths cannot be avoided due to the splitting of the incident polychromatic emission into 4 polychromatic beams, each having at least 6 dB less optical power. For demultiplexing, the introduction of a dispersive mechanism, such as through a cascaded filter structure, prism, or diffraction grating is the preferred technique.

Depending on the application, separate devices for multiplexing and demultiplexing may be desirable, while for other applications, a symmetric physical mechanism for multiplexing and demultiplexing is preferred.

What is claimed is:

1. An optical multiplexing device comprising in part:
a first array of a first dimension of curved transmissive surfaces to individually collimate light from an array of light sources,
a second array of curved transmissive surfaces of a second dimension that is at least one order smaller than said first dimension with each curved surface from said second array formed to focus a plurality of said collimated beams of different wavelengths onto a single optical fiber,
a first mechanical assembly to create a designated distance between said second array of lenses and an array of optical fibers or to provide lateral spatial alignment between each curved surface of second array and an optical fiber.

2. The device of claim 1, further including a planar reflective surface between said first and second arrays to steer said collimated light by a designated angle.

3. The device of claim 1, further including a second mechanical assembly that positions said light sources a designated distance from said first array of curved surfaces.

4. The device of claim 1, further including a second mechanical assembly that provides a selected lateral spatial alignment between each curved surface of said first array and said light sources.

5. The device of claim 1, wherein said surfaces and said distance between said surfaces are provided by way of a unitary body.

6. The device of claim 5, wherein said unitary body and said surfaces are made of the same optically transparent substance selected from a list comprising glass and polymer resin.

7. The device of claim 1, wherein said first dimension of said first array of curved surfaces is one or two-dimensional, and said second dimension of said second array of curved surfaces is zero.

8. The device of claim 1, wherein said first dimension of said first array of curved surfaces is two and said second dimension of said second array of curved surfaces is one.

9. The device of claim 1, wherein curved surfaces of said first and second array are coated with a coating that is antireflective in a designated wavelength range.

10. The device of claim 2, wherein said planar reflective surface steers said collimated beams by ninety degrees.

11. The device of claim 1, wherein said curved surfaces can be described by an aspheric surface sagitta.

12. The device of claim 1, wherein said first mechanical assembly is shaped to receive a standard fiber optical connector.

13. The device of claim 3, wherein said second mechanical assembly is shaped to receive a standard transistor outline (TO) header or a transistor outline (TO) cap.

14. An optical multiplexing device comprising in part:
a first array of a first dimension of curved surfaces to individually collimate light from an array of light sources,
a second array of curved reflective surfaces of a second dimension that is at least one order smaller than said first dimension with each curved surface of said second array formed to steer said collimated light beams of different wavelengths by a designated angle and to focus a plurality of said collimated light beams of different wavelengths onto a single optical fiber.
a receptacle to accept a standardized fiber connector and to establish a designated distance and lateral alignment between each curved surface of said second array of curved surfaces and a fiber termination.

15. The device of claim 14, further including a mechanical assembly to position said light sources a designated distance from said first array of curved surfaces.

16. The device of claim 15, further including a mechanical assembly that provides a selected lateral spatial alignment between each curved surface of said first array and each light source of said array of light sources.

17. The device of claim 14, wherein said surfaces and said distance between said surfaces are provided by way of a unitary body.

18. The device of claim 17, wherein said unitary body and said surfaces are made of the same optically transparent substance selected from a list comprising glass and polymer resin.

19. The device of claim 14, wherein said first dimension of said first array of curved surfaces is one or two-dimensional, and said second dimension of said second array of curved surfaces is zero.

20. The device of claim 14, wherein said first dimension of said first array of curved surfaces is two and said second dimension of said second array of curved surfaces is one.

21. The device of claim 14, wherein surfaces of said first and second array of curved surfaces are coated with a coating that is antireflective in a designated wavelength range.

22. The device of claim 14, wherein said designated angle is ninety degrees.

23. The device of claim 14, wherein said curved surfaces can be described by an aspheric surface sagitta.

24. An integrated optical multiplexing device comprising a waveguide combiner positioned to provide optical paths having a selected curvature, the waveguide combiner including a plurality of input waveguides having entrance facets aligned along a first axis and a single output waveguide, and wherein said waveguide combiner simultaneously multiplexes a plurality of light beams of different wavelengths and steers the light along said selected curvature and bends the light by a designated angle.

25. The device of claim 24, including a plurality of said waveguide combiners arranged in an array, wherein said array of waveguide combiners simultaneously multiplexes a plurality of light beams of different wavelengths and steers the light by said designated angle and selected curvature.

26. The device of claim 25, wherein said waveguide combiners are stacked such that the output waveguide of each waveguide combiner has an output end that is aligned along a second axis that is perpendicular to the first axes of the input waveguides of each waveguide combiner.

27. The device of claim 26, wherein said input waveguides have an input end having a longitudinal axis and the output waveguide has an output end having a longitudinal axis, and further wherein the longitudinal axis of the input end and the longitudinal axis of the output end are perpendicular to said first and second axes.

28. The device of claim 24, wherein said designated angle is ninety degrees.

29. The device of claim 28, further including a first array of curved surfaces wherein each curved surface focuses light from a light source onto said input waveguide entrance facet.

30. The device of claim 29, further including a first mechanical assembly to create a designated distance between said first array of curved surfaces and said array of light sources.

31. The device of claim 30, further including a first mechanical assembly that provides a selected lateral spatial alignment between said first array of curved surfaces and said array of light sources.

32. The device of claim 28, further including a second array of curved surfaces wherein each curved surface focuses light from each output waveguide to an optical fiber entrance facet.

33. The device of claim 32, further including a second mechanical assembly to create a designated distance between said second array of curved surfaces and an array of optical fibers.

34. The device of claim 33, further including a second mechanical assembly that provides a selected lateral spatial alignment between said second array of curved surfaces and said array of optical fibers.

35. A method of fabricating said device of claim 34, wherein said waveguide combiner is formed by attaching a preformed polymer waveguide combiner to a curved face of a unitary mold structure formed of an optically transparent substance selected from a list comprising glass and polymer resin, wherein the unitary mold structure includes said first and second arrays of curved surfaces formed of the optically transparent substance.

36. A method of fabricating said device of claim 34, wherein said waveguide combiners are formed in preformed waveguide channels in a mold structure, wherein the mold structure includes said first and second arrays of curved surfaces formed using a first polymer resin, and further wherein the preformed waveguide channels have been filled with a second polymer resin having a higher refractive index than said first polymer resin to form the waveguide combiners.
